(19) United States
(12) Patent Application Publication
(10) Pub. No.: US 2008/0167772 A1
(43) Pub. Date: Jul. 10, 2008

(54) Method and system for processing and transmitting automotive emission data

(76) Inventors: Sterling Du, Kaohsiung City (TW); Xiaoguang Yu, Wuhan (CN)

Correspondence Address: Wang Law Firm, Inc., 4989 Peachtree Parkway,, Suite 200, Norcross, GA, 30092, US

(21) Appl. No.: 11/649,689

(22) Filed: Jan. 4, 2007

(51) Int. Cl. G06F 19/00

(52) U.S. Cl. 701/33; 701/29; 340/438

(57) ABSTRACT

An emission performance processing system for transmitting emission data of a vehicle to a remote server and inspecting emission performance of the vehicle is provided. The system includes a control unit, an OBD connector, a first storage unit and a transceiver. The system receives OBD data from an OBD system embedded in the vehicle via the OBD connector. The control unit extracts emission data from the OBD data. The first storage unit is used to store identification data of the vehicle. The identification data and the emission data are pre-processed by the control unit and transmitted to a remote server by the transceiver. The transceiver is also used to receive inquiries and evaluation reports from the remote server.

### FIELD OF THE INVENTION

The invention relates to an application of automobile diagnostic information and more specifically to communicating automobile emission data wirelessly to a remote server.

### BACKGROUND OF THE INVENTION

On-Board Diagnostic systems (OBD) are widely used in automotive vehicles. Through some sensors and electronic devices located within the vehicles, some useful information, such as the emission performance, could be gathered. Conventionally, motor vehicle manufacturers had their own diagnostic systems which were not compatible with each other. Different systems had different definitions of error codes which could only be understood by equipments from the same manufacturer. Therefore, when the vehicles were under repair, technicians had to use different diagnostic equipments to inspect vehicles from different manufacturers. In 1988, the Society of Automotive Engineers (SAE) set standards including a standardized, serial 16-cavity connector plug and a set of standardized Diagnostic Trouble Codes (DTC). This standardized diagnostic system indicates a second generation of OBD, which is called OBD-II. OBD-II is capable of providing more comprehensive engine control and monitoring more components of the vehicles.

OBD data from the above mentioned system is made available through the standardized OBD connector. However, the OBD data, which is conventionally stored in a storage unit located in the vehicle, could only be accessed by technicians when the vehicle is at a service center. In order to inspect emission performance of the vehicle, the driver has to drive the vehicle to the service center. Some drivers may be reluctant to drive their vehicles to the service center because this is time-consuming and inconvenient. Besides, it is difficult to monitor and manage the emission performance of a large number of vehicles since it is almost impossible to compel all the drivers to go to the service center on a regular basis.

In some prior arts, methods for transmitting wirelessly the OBD data have been used. However, the OBD data is generally sent to a server without being pre-processed, which may reduce the efficiency of the remote server.

Therefore, it is to a system that is able to collect emission data from an OBD system and transmit the emission data to a remote server wirelessly for further analysis and management and, at the same time, provide a data pre-processing function at the vehicle before transmitting the emission data to the remote server that the present invention is primarily directed.

### SUMMARY OF THE INVENTION

The present invention provides a system for inspecting emission performance of a vehicle. Advantageously, drivers are able to acquire emission performance information of the vehicles by receiving a wireless evaluation report from the remote server without driving the vehicles to the service center. More advantageously, the efficiency of the remote server can be improved by providing a data pre-processing feature in the system before transmitting the emission data to the remote server.

In one embodiment of the invention, there is provided a system for processing and transmitting emission data of a vehicle. The system includes an OBD connector, a first storage unit, a control unit and a transceiver. The OBD connector is capable of receiving OBD data from an OBD system embedded in said vehicle. The first storage unit is used to store identification data of said vehicle. The control unit is in communication with the OBD connector and the first storage unit. The control unit is capable of extracting emission data from the OBD data and packing the emission data and the identification data into data packets with a predetermined format. The transceiver is in communication with the control unit. The transceiver is capable of receiving inquiries from the remote server and transmitting the emission data with the identification data to the remote server.

In yet another embodiment of the invention there is also provided a method for processing and transmitting emission data of a vehicle. The method includes acquiring OBD data from an OBD system embedded in the vehicle, extracting emission data from the OBD data, obtaining identification data of the vehicle, packing the emission data and identification data into data packets, and transmitting the data packets to a remote server. Moreover, the method further includes generating an evaluation report at the remote server based on the emission data and the identification data, and transmitting the evaluation report from the remote server to the vehicle.

### BRIEF DESCRIPTION OF THE DRAWINGS

Features and advantages of embodiments of the invention will become apparent as the following Detailed Description proceeds, and upon reference to the Drawings, where like numerals depict like elements, and in which:

FIG. 1 illustrates an exemplary architecture of a system for inspecting emission performance of a vehicle; and

FIG. 2 illustrates an exemplary flow chart for inspecting emission performance of a vehicle.

### DETAILED DESCRIPTION OF THE INVENTION

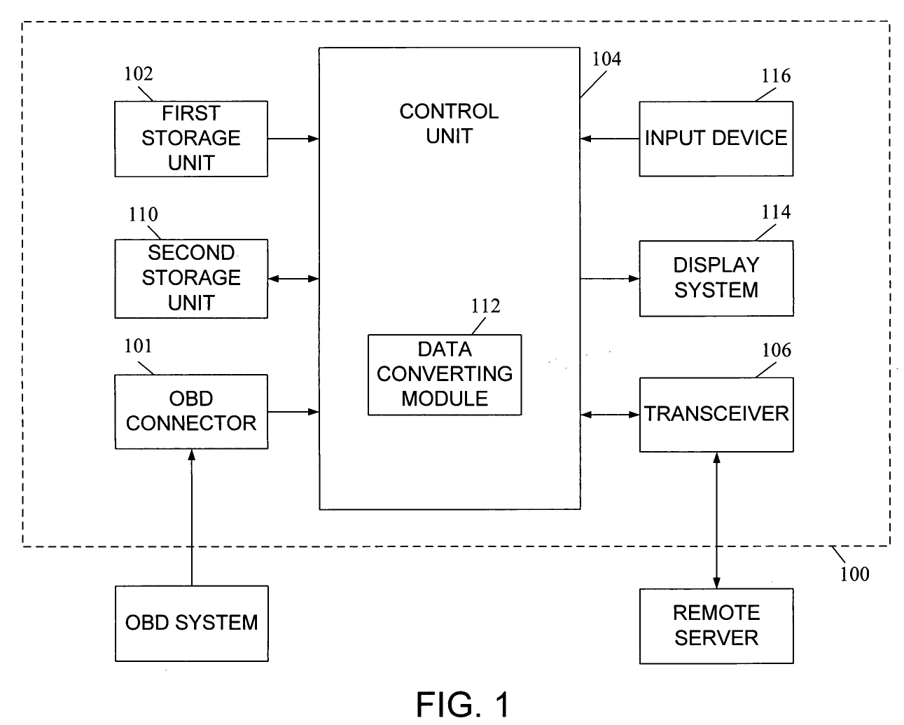

FIG. 1 illustrates an exemplary architecture of an emission performance processing system 100, which is capable of receiving OBD data from an OBD system, extracting emission data from the OBD data, and transmitting the emission data with identification data of the vehicle to a remote server. Furthermore, the system is also capable of receiving inquiries and evaluation reports from the remote server, and displaying the evaluation reports on a display system.

The OBD system utilizes a plurality of sensors to monitor various components of the vehicle. Some of these components may directly or indirectly affect the vehicle's emission performance. Through the OBD system, information of the vehicle, referred to as OBD data herein, can be gathered.

The emission performance processing system 100 includes an OBD connector 101, a first storage unit 102, a second storage unit 110, a control unit 104 and a transceiver 106. The emission performance processing system 100 is in communication with an OBD system embedded in the vehicle through the OBD connector 101. The OBD data received from the OBD system is sent to the control unit 104 for further analysis via the OBD connector 101. The OBD data contains information of various aspects of the vehicle. In order to inspect emission performance of the vehicle, emission data need to be extracted from the OBD data.

The OBD data provided by the OBD system may be presented as a set of Diagnostic Trouble Codes (DTC). In an OBD-II system, each DTC is made up of 5 digits and has a specific meaning. For example, the DTC “P0440” means “evaporative emission control system malfunction”. The control unit 104 is capable of selecting the DTCs which are related to emission performance from a set of DTCs and storing these emission-related DTCs in the second storage unit 110 or sending these emission-related DTCs to the transceiver 106. The control unit 104 can generate a message indicative of the emission performance of the vehicle based on the DTCs. The control unit 104 is further capable of analyzing the emission-related DTCs and generating a transmission command when a DTC indicates a possible problem with the vehicle.

The first storage unit 102 is coupled to the control unit 104 for storing identification data which represents the unique identity of the vehicle. The identification data can be a Vehicle Identification Number (VIN), License Plate Number, or some other identification means that uniquely identifies the vehicle. The first storage unit 102 can not be written, erased, or otherwise modified by unauthorized users. It should be noted the first storage unit 102 and the secondary storage unit 110 can be two separate devices, or two different parts of a single device.

The control unit 104 includes a data converting module 112. At the data converting module 112, the emission data and the identification data are pre-processed. In one embodiment of the invention, the pre-processing includes packing the emission data and identification data into data packets with a predetermined format which can be recognized and processed by a remote server. A data packet may have several segments including a head, a vehicle ID field, a data field, a data count field, a checksum and a tail. Each segment has a predetermined length. The head of a packet indicates the beginning of the packet. The vehicle ID field contains identification data of the vehicle. The data field contains emission-related DTCs for the vehicle. The data count field indicates the number of DTCs being transmitted. The check sum is used to test for overall packet integrity. The tail of the packet indicates the end of the packet.

If several DTCs are transmitted simultaneously from one single vehicle and the remote server may be too busy receiving these data, the server may not be able to respond to data from other vehicles. However, in this embodiment, with the predetermined format of the data packet, DTCs from a single vehicle can be packed into several packets and transmitted sequentially. Advantageously, the processing capacity of the remote server may be maximized and the efficiency may be improved.

More advantageously, with a known position of the vehicle ID field in a packet, the remote server can quickly distinguish packets from different vehicles and process them separately. Consequently, the efficiency of the remote server may be further improved.

The transceiver 106 is in communication with the control unit 104. It is capable of transmitting the data packets via a radio access network (wireless communication network) to a remote server. The transceiver 106 is further capable of receiving inquiries from the remote server, such as a transmission command asking the vehicle to transmit the data packets to the remote server. The transceiver 106 is further capable of receiving an evaluation report from the remote server, such as a message indicating whether the emission performance of the vehicle can meet a predetermined standard.

The transmission of the data packets to the remote server occurs under many circumstances, including:
(a) when the vehicle receives an inquiry from the remote server;
(b) when the control unit generates a transmission command;
(c) at a configurable predetermined time interval;
(d) at a configurable predetermined mileage interval.

It is appreciated by those skilled in the art that the wireless transmission protocols used by the system to transmit the data from the vehicle to the remote server may include, but not limited to, GSM, CDMA, TDMA, FDMA, and WLAN protocols.

The remote server sends inquiries to the vehicle, receives the data packets from the vehicle, recovers the emission data and identification data from the data packets and stores the data in a database for analysis and management. The remote server is capable of analyzing the data with further concerns about the identity of the vehicle and generating an evaluation report of the emission performance for the vehicle.

The remote server may compare the received emission data with a preset value, produces an evaluation report indicating whether the emission performance meets a predetermined standard, and then sends the evaluation report back to the vehicle. The preset value is determined according to the identity of the vehicle. For example, a car and a truck can be distinguished by the remote server according to their identification data so their emission data are compared with two different preset values respectively.

In addition, the emission performance processing system may further include a display system 114, for example, a Liquid Crystal Display (LCD) monitor, for displaying the message indicative of the emission data and displaying the evaluation report from the remote server. Furthermore, the emission performance processing system may also include an input device 116 for receiving commands from the user input through a keyboard or a touch panel.

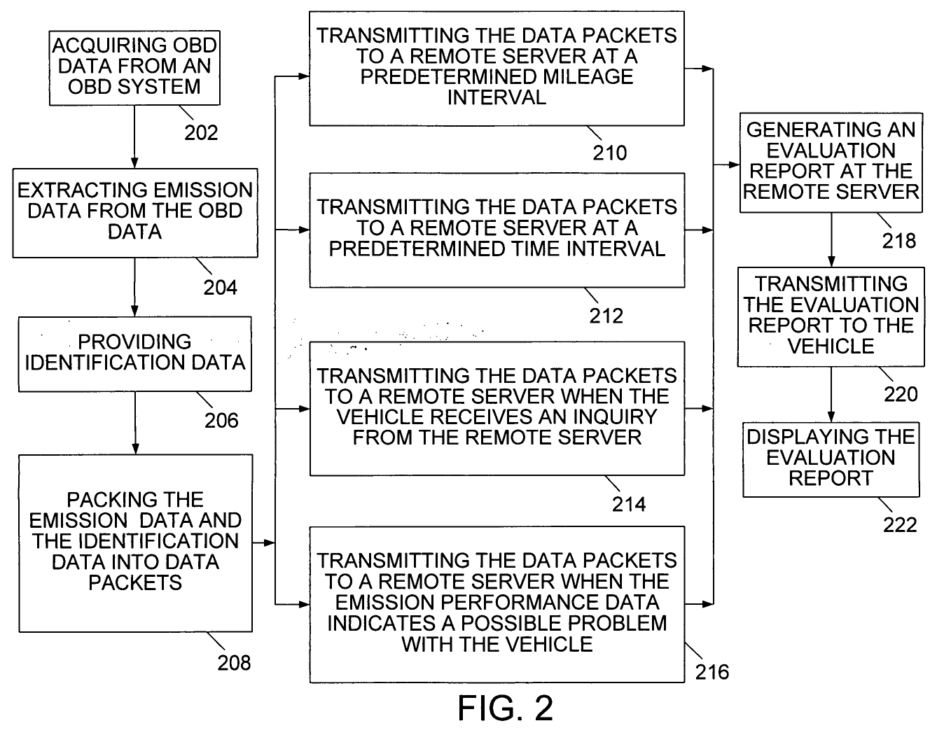

FIG. 2 illustrates an exemplary flow chart for inspecting emission performance of a vehicle and transmitting inspection data to a remote server. In operation, the OBD data is received from an OBD system embedded in the vehicle through an OBD connector, step 202. After the OBD data is received, the emission performance processing system extracts emission data from the OBD data, step 204. Meanwhile, the processing system retrieves a unique identification data from a storage unit, step 206. Then, the processing system packs the emission data and the identification data into data packets with a predetermined format, step 208, and transmit the data packets to a remote server. The transmission may occur in several modes. In a batch mode, the data packets are transmitted according to a predetermined schedule. In one embodiment, the predetermined schedule may include transmitting the data packets to the remote server at a predetermined mileage interval, step 210. In another embodiment, the predetermined schedule may include transmitting the data packets to the remote server at a predetermined time interval, step 212. In an on-demand mode, the transmission to the remote server occurs when the vehicle receives an inquiry from the remote server, step 214. In a real-time mode, the transmission to the remote server occurs when the emission data indicates a possible problem with the vehicle, step 216. At the remote server, an evaluation report is generated based on the emission data and the identification data recovered from the data packets, step 218. The evaluation report is transmitted back to the vehicle, step 220, and displayed on a display system, step 222.

It should be noted that the OBD system which is in communication with the emission performance processing system can be a first generation OBD system or a second generation OBD system (OBD-II). Accordingly, the OBD data mentioned here can be generated by a first generation OBD system or a second generation OBD system.

The terms and expressions which have been employed herein are used as terms of description and not of limitation, and there is no intention, in the use of such terms and expressions, of excluding any equivalents of the features shown and described (or portions thereof, and it is recognized that various modifications are possible within the scope of the claims. Other modifications, variations, and alternatives are also possible. Accordingly, the claims are intended to cover all such equivalents.

What is claimed is:

1. A system resident on a vehicle for processing and transmitting automotive emission data, comprising:
an On-Board Diagnostic (OBD) connector for receiving OBD data from an OBD system embedded in said vehicle;
a first storage unit for storing identification data of said vehicle;
a control unit in communication with said OBD connector and said first storage unit, said control unit being capable of extracting automotive emission data from said OBD data, said control unit further being capable of packing said emission data and said identification data into data packets with a predetermined format.; and
a transceiver in communication with said control unit for receiving inquiries from the remote server and transmitting said data packets to said remote server via a radio access network.

2. The system of claim 1, wherein said transceiver transmits said data packets to said remote server after receiving a request from said remote server.

3. The system of claim 1, wherein said transceiver transmits said data packets to said remote server periodically.

4. The system of claim 1, wherein said transceiver transmits said data packets to said remote server at a predetermined mileage interval.

5. The system of claim 1, wherein said transceiver transmits data packets to said remote server when said emission data indicates a possible problem with said vehicle.

6. The system of claim 5, wherein said control unit is capable of analyzing said emission data and generating a transmission command when the performance data indicates a possible problem with said vehicle.

7. The system of claim 1, further comprising:
a second storage unit coupled to said control unit for storing said emission data.

8. The system of claim 1, further comprising:
a display system for displaying said emission data of said vehicle and displaying emission performance report from said remote server.

9. The system of claim 1, wherein said control unit comprises:
a data converting module for packing said emission data and said identification data into data packets with a predetermined format before transmitting said emission data and said identification data to said remote server.

10. The system of claim 1, wherein said transceiver further comprising a GSM transceiver module.

11. The system of claim 1, wherein said transceiver comprises:
a CDMA transceiver module.

12. The system of claim 1, wherein said transceiver comprises:
a WLAN transceiver module.

13. A method for processing and transmitting emission data of a vehicle, comprising:
acquiring OBD data from an OBD system embedded in said vehicle;
extracting emission data from said OBD data;
obtaining identification data of said vehicle;
packing the emission data and the identification data into data packets; and
transmitting said data packets to a remote server.

14. The method of claim 13, wherein the step of providing identification data of said vehicle further comprising:
reading said identification data from a storage unit located within said vehicle.

15. The method of claim 13, further comprising:
generating an evaluation report at said remote server based on said emission data and said identification data which are recovered from said data packets; and
transmitting said evaluation report from said remote server to said vehicle.

16. The method of claim 13, wherein said data packets are transmitted to said remote server at the request of said remote server.

17. The method of claim 13, wherein said data packets are transmitted to said remote server periodically.

18. The method of claim 13, wherein said data packets are transmitted to said remote server at a predetermined mileage interval.

19. The method of claim 13, wherein said data packets are transmitted to said remote server when said emission data indicates a possible problem with said vehicle.

20. The method of claim 13, further comprising:
displaying said evaluation report on a display system located within said vehicle.
